(19) United States
(12) Patent Application Publication
(10) Pub. No.: US 2026/0123625 A1
(43) Pub. Date: May 7, 2026

(54) AGROCHEMICAL COMPOSITION FOR SEED COATING

(71) Applicant: MELCHIOR MATERIAL AND LIFE SCIENCE FRANCE, LACQ (FR)

(72) Inventors: Yannick ESCUDIE, NOUSTY (FR); Tanguy SORLIN, ARTIX (FR); Olivier GUERRET, PERN (FR)

(73) Assignee: MELCHIOR MATERIAL AND LIFE SCIENCE FRANCE, LACQ (FR)

(21) Appl. No.: 18/706,326

(22) PCT Filed: Dec. 21, 2022
(86) PCT No.: PCT/FR2022/052467

§ 371 Date: Apr. 30, 2024

(30) Foreign Application Priority Data
Dec. 21, 2021 (FR) FR2114084

(51) Int. Cl. A01N 25/10; A01N 25/28; A01P 21/00

(52) U.S. Cl. CPC A01N 25/10; A01N 25/28; A01P 21/00

(57) ABSTRACT

The present invention relates to a composition comprising particles suspended in an aqueous phase, wherein: said particles comprise a solid shell surrounding a core, wherein: —the solid shell comprises at least one HASE-type copolymer, and —the core represents at least 90 wt. %, in particular from 90 to 99.5 wt. %, of the total weight of the particles and comprises a mixture of wax, oil and a semiochemical compound, the aqueous phase comprises at least one ASE-type copolymer and a base selected from ammonium hydroxide, sodium hydroxide, potassium hydroxide and combinations thereof, so that the aqueous phase has a pH of between 7 and 9.5, preferably between 7 and 8. The present invention also relates to a kit comprising: —a first, in particular agrochemical, composition comprising particles suspended in an aqueous phase, wherein: said particles comprise a solid shell surrounding a core, wherein: —the solid shell comprises at least one HASE-type copolymer, and —the core represents at least 90 wt. %, in particular from 90 to 99.5 wt. %, of the total weight of the particles and comprises a mixture of wax, oil and a semiochemical compound, and —a second composition comprising, in an aqueous phase, at least one ASE-type copolymer and a base selected from ammonium hydroxide, sodium hydroxide, potassium hydroxide and combinations thereof, so that the aqueous phase has a pH of between 7 and 9.5, preferably between 7 and 8. The present invention also relates to a method for preparing this composition, to a method for treating a seed with such a composition or such a kit, to the seed thus treated and to the use of this composition or of this kit to protect a seed, more particularly which is intended to be sown, and/or an emerging seedling from an insect or nematode pest.

### TECHNICAL FIELD OF THE INVENTION

The present invention relates to compositions and kits, in particular agrochemical compositions, comprising a semiochemical compound, and more particularly a repellent compound against pest insects or nematodes, intended to treat seeds in order to protect them against pest insects or nematodes. Indeed, the compositions and kits according to the invention allow to protect the crops from sowing to emergence of the plant, by diffusing in the soil, in a prolonged way, a semiochemical compound to which pest insects and nematodes present in the soil are sensitive.

### STATE OF THE ART

Many technologies are currently used to treat seeds with the purpose of improving crop performances, for example by stimulating plant growth or by protecting seeds from harmful and undesirable organisms, such as pest insects or nematodes.

A range of fungicide treatments using liquids and/or slurries have long been used to control soil-borne diseases in seeds. Recent developments in seed treatments have focused on the use of techniques to deliver pesticides, particularly insecticides, to the seeds, notably via the technique of seed coating.

One of the problems encountered with seed coating is the phytotoxic effect of the active ingredients contained in the coating. In the past, the concentration of the active ingredients in the seed coating was limited. Now, the coating itself is used to protect the seed from the phytotoxicity of active ingredients, such as insecticides.

U.S. Pat. No. 7,836,630 describes a coating method using a polymer to form a tight barrier between the seed and the active ingredient that is phytotoxic. Many polymers are mentioned, including, among others, natural polysaccharides, cellulose derivatives, or more classical polymers such as polyacrylic acid derivatives or PVA. This document describes a coating formed in two steps by applying an insulating layer devoid of any active ingredient around the seed, followed by the application of the active ingredient. Thus, the insulating layer has no active role in the release and diffusion of the active ingredient, and no specific protection of the active ingredient is provided.

WO2011/133765 discloses a pH-sensitive encapsulation method capable of releasing an active ingredient when the seed is exposed to a pH change. The active ingredient may be a phytosanitary active ingredient, an attractant or a repellent. However, this method has the disadvantage of being pH-dependent and using a polymer which generates microparticles that can pollute the soil when degraded in it.

WO2014/062660 discloses a method of coating seeds using a first polymer to encapsulate the active ingredient by forming a rigid shell around it and a second polymer to adhere the encapsulated active ingredient particles to the seed and allow controlled release of the active ingredient. The encapsulating polymers used are SMA (“styrene maleic anhydride”) or SMI (“styrene maleimide”) polymers, modified or unmodified proteins, or starches. The coating is described as biodegradable. However, due to the use of thermoplastic polymer, microplastics will be generated in the soil, which is an obstacle to the development of this technology. Thus, the coating agents are in most cases of various types of polymers, which can generate soil pollution via the formation of microplastics in particular.

In addition, the very use of insecticides in coatings poses environmental problems due to the persistence of the insecticide in the soil and its migration to surface water and groundwater. Indeed, the insecticide does not degrade by itself, hence it accumulates over time, in the soil and in water.

Repellent agents can be used in place of agrochemical active ingredients such as insecticides. However, said repellent agent must be present at least during seed germination and plant emergence. But in most cases, repellent agents are volatile, even very volatile, making their effectiveness rather short-lived. Thus, a crucial problem arises regarding the rapid loss of active ingredient that renders a coating containing a repellent agent ineffective in protecting the seed against soil-borne pests.

There is therefore a need to develop new treatments, such as coatings for seeds allowing an effective treatment of seeds against pests over time, without generating phytotoxicity problems or soil and groundwater pollution.

### SUMMARY OF THE INVENTION

The composition and kit according to the invention intended for coating seeds allows solving the above-mentioned problems. In particular, it allows to overcome the problem of direct phytotoxicity of the active ingredient (i.e., the semiochemical compound in the sense of the invention) on the seeds, in particular during the seed germination and plant emergence phase; the problem of soil pollution by plastic polymers or by insecticides; and the problem of too rapid disappearance of the active ingredient due to its volatility or its leaching by water.

In addition, the difficulty often faced by the person skilled in the art in making these seed coatings consists in obtaining seeds with an acceptable flowability for handling in seeders. The solution provided in the present invention leads to coated seeds that are easily flowable in seeders.

Thus, the present invention relates to a composition, in particular an agrochemical composition, comprising particles suspended in an aqueous phase, wherein:
said particles comprise a solid envelope surrounding a core, wherein:
   the solid envelope comprises at least one HASE copolymer, and
   the core represents at least 90% by weight, in particular from 90 to 99.5% by weight, of the total weight of the particles and comprises a mixture of wax, oil and a semiochemical compound,
the aqueous phase comprises at least one ASE copolymer and a base selected from ammonium hydroxide, sodium hydroxide, potassium hydroxide and combinations thereof, such that the aqueous phase has a pH of between 7 and 9.5, preferably between 7 and 8. The composition according to the invention is intended more particularly for treating seeds by coating.

The present invention also relates to a kit comprising:
a first composition, in particular of the agrochemical type, comprising particles suspended in an aqueous phase, wherein:
said particles comprise a solid envelope surrounding a core, wherein:
the solid envelope comprises at least one HASE copolymer, and
the core represents at least 90% by weight, in particular from 90 to 99.5% by weight, of the total weight of the particles and comprises a mixture of wax, oil and a semiochemical compound, and
a second composition comprising, in an aqueous phase, at least one ASE copolymer and a base selected from ammonium hydroxide, sodium hydroxide, potassium hydroxide and combinations thereof, so that the aqueous phase has a pH of between 7 and 9.5, preferably between 7 and 8.

More particularly, the kit according to the invention makes it possible to treat seeds by first applying the second composition to coat the seed with a film of ASE copolymer, and then applying the first composition, for example in one or more times, to adhere the semiochemical compound particles to the ASE copolymer coating the seed.

The composition and kit according to the invention thus makes it possible to form a coating around the seed, this coating comprising capsules/particles trapping the active agent, namely the semiochemical compound. The coating polymer creates a protective layer around the seed to prevent the semiochemical compound, once released from the particles, from coming into contact with the seed. When the particles are included in the coating polymer, its water-soluble nature also allows the active agent particles to be gradually released into the soil near the seed. In addition, due to its solid and hydrophobic character, the envelope of the active agent particles (based on HASE copolymer) protects both the seed from the phytotoxic effects of the active agent (since the seed remains isolated from the semiochemical compound) and the active agent itself from the external environment and in particular from water. The envelope thus allows a controlled release of the active agent contained in the particles. The active agent is released progressively in time, allowing to protect the seed during the germination and emergence phase of the plant.

Another object of the present invention is a method for preparing a composition according to the invention, comprising the following steps:
(i) preparing an aqueous suspension of the particles;
(ii) adding the at least one ASE copolymer; and
(iii) adding the base so as to obtain a pH between 7 and 9.5, preferably between 7 and 8.

The present invention also relates to a method of treating a seed comprising:
the application to the seed of a composition according to the invention, and more particularly the coating of a seed with a composition according to the invention, or
the application to a seed of the second composition of the kit according to the invention, more particularly by coating; then the application, in one or more times, to the seed previously covered, in particular coated, with the second composition of the kit according to the invention, of the first composition of the kit according to the invention.

The present invention therefore also relates to a seed treated, in particular coated, with a composition according to the invention or using the kit according to the invention, in particular obtainable by the above-mentioned treatment method.

The present invention also relates to the use of a composition or kit according to the invention to protect a seed, more particularly intended to be sown, and/or an emerging seedling against a pest insect or nematode.

### DETAILED DESCRIPTION OF THE INVENTION

### Definitions

By “pest insect or nematode” is meant, in the context of the present invention, an insect (including an insect larva) or a nematode considered harmful to an agricultural crop. More particularly, it is a pest that attacks the subterranean parts of the plant (seed, germ, root system). In the following, pest insects and nematodes will be referred to as “pests” or “soil pests”.

By “semiochemical compound” is meant, in the context of the present invention, a substance detected by a pest as defined above and keeping said pest away from the seed or seedling to be protected without lethal effect. The semiochemical compound is generally volatile but may also be diffused into the soil due to its solubility in water. Preferably, the semiochemical compounds are terpene-type compounds, particularly of natural origin. Semiochemical compounds can also be aldehydes, esters or jasmonic derivatives.

By “wax” is meant, in the context of the present invention, a lipophilic compound that is solid at room temperature (about 25° C.) and atmospheric pressure (1013.25 hPa), preferably of natural origin.

By “oil” is meant, in the context of the present invention, a fatty compound which is liquid at room temperature (about 25° C.) and atmospheric pressure (1013.25 hPa), immiscible with water and non-volatile.

By “ASE copolymer” (ASE being the abbreviation of “Alkali Swellable Emulsion”), we mean, in the context of the present invention, a copolymer of (meth)acrylic acid and alkyl acrylate, in particular a copolymer of methacrylic acid and ethyl acrylate, obtained by radical emulsion polymerization. Such a polymer has the property, upon neutralization with a base such as sodium, potassium or ammonium hydroxide, of becoming water-soluble.

By “HASE copolymer” (HASE being the abbreviation of “Hydrophobically modified Alkali Swellable Emulsion”) is meant, in the context of the present invention, an ASE copolymer, as defined above, obtained from the same mixture of monomers, and additionally comprising a hydrophobic macromonomer of the following formula Chem. I:

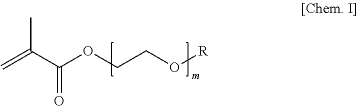

wherein:
   m is an integer between 1 and 40, preferably between 10 and 30, and
   R a hydrocarbon group of formula CₙH₂ₙ₊₁ in which n is an integer between 9 and 25, preferably between 10 and 22 and even more preferably equal to 12.

The R group is therefore hydrophobic.

By “emergent seedling” is meant, in the context of the present invention, a seedling during its emergence phase from the germinated seed stage to the seedling stage. The emergence period can be more or less long depending on the plant and lasts until the plant is robust enough to defend itself against soil pests.

### Composition and Kit

The composition according to the invention, in particular an agrochemical composition, and the kit according to the invention, in particular of the agrochemical type, thus comprise particles suspended in an aqueous phase.

The particles comprise a solid envelope surrounding a core. The particles, suspended in an aqueous phase, advantageously represent from 1% to 70%, in particular from 1% to 50%, in particular from 1% to 20%, by weight of the total weight of the composition.

The solid envelope comprises, in particular consists of, at least one HASE copolymer. Advantageously, the HASE copolymer comprises, in particular consists of, based on the total weight of the copolymer:
between 30% and 40% by weight of repeating units derived from methacrylic acid,
between 45% and 60% by weight of repeating units derived from ethyl acrylate, and
between 5% and 20% by weight of repeating units derived from a macromonomer of the following formula Chem. I:

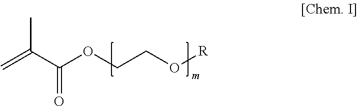

wherein:
   m is an integer between 1 and 40, preferably between 20 and 40, and
   R a hydrocarbon group of formula CₙH₂ₙ₊₁ in which n is an integer between 9 and 25, preferably between 10 and 20 and even more preferably equal to 12.

The HASE copolymer can be prepared, for example, according to one of the methods described in WO2011/104599, WO2011/104600 and EP1778797. It can be Pharma 38 from Coatex.

The core represents at least 90% by weight, in particular from 90% to 99.5% by weight, of the total weight of the particles and comprises a mixture of wax, oil and a semiochemical compound.

The waxes which may be used in a composition according to the invention may be selected from animal waxes, vegetable waxes, mineral waxes, synthetic waxes and mixtures thereof. As a wax of animal origin, we may mention beeswax, lanolin wax or even Chinese insect wax. As a wax of plant origin, we can mention rice wax, carnauba wax, candelilla wax, jojoba wax, ouricurry wax, esparto wax, cork fiber wax, sugar cane wax, Japan wax, or sumac wax. As a mineral wax, we can mention montan wax, microcrystalline waxes, kerosenes, or ozokerite. As synthetic waxes, we can mention polyethylene waxes, waxes obtained by the Fisher-Tropsch synthesis, or waxy copolymers and their esters. Mention may also be made of waxes obtained by catalytic hydrogenation of animal or plant origin oils having unsaturated, linear or branched, C8-C32 fatty chains. These include hydrogenated jojoba oil, hydrogenated sunflower oil, hydrogenated castor oil, hydrogenated coconut oil and hydrogenated lanolin oil, as well as di-(1,1,1-trimethylol propane) tetrastearate. Waxes obtained by transesterification and hydrogenation of plant origin oils, such as castor oil or olive oil, such as the waxes sold under the names Phytowax castor 16L64®, Phytowax castor 22L73® and Phytowax Olive 18L57® by SOPHIM, can also be used.

Advantageously, the wax is selected from the group consisting of beeswax, lanolin wax, Chinese insect wax, rice wax, carnauba wax, candelilla wax, jojoba wax, ouricurry wax, esparto wax, cork fiber wax, sugar cane wax, Japan wax, sumac wax, montan wax, microcrystalline waxes, and mixtures thereof.

The oil according to the invention may be selected from plant origin oils. In particular, the oil according to the invention will be selected from the group consisting of sunflower oil, peanut oil, soybean oil, rapeseed oil, corn oil, olive oil, grape oil, walnut oil, linseed oil, palm oil, coconut oil, argan oil, avocado oil, almond oil, hazelnut oil, pistachio oil, rice oil, cottonseed oil, wheat germ oil, sesame oil, and mixtures thereof.

The semiochemical compound may be selected from the terpene derivatives, aldehydes, esters such as acetates, jasmonic derivatives, and mixtures thereof, these molecules preferably being naturally emitted by plants. Preferably, the semiochemical compound will be selected from terpene derivatives, aldehydes, esters such as acetates, and mixtures thereof, these molecules preferably being naturally emitted by plants.

As an example, the terpene derivative, preferably naturally emitted by plants can be thymol, geraniol, pinenes (alpha or beta), limonene, camphor, camphene, sabinene, menthol, eucalyptol, β-caryophyllene, β-ocimenes, citronellol, linalool and its acetate, lavandulyl acetate, terpineols, terpinenes, or mixture thereof; in particular may be thymol, geraniol, pinenes (alpha or beta), limonene, camphor, menthol, eucalyptol, β-caryophyllene, β-ocimenes, linalool and its acetate, lavandulyl acetate, terpineols, terpinenes, or a mixture thereof.

The aldehyde, preferably naturally emitted by plants, will more particularly be an aldehyde having from 5 to 18 (e.g., 6 to 16) carbon atoms and comprising a saturated or unsaturated hydrocarbon chain (e.g., comprising one or more, in particular 1 or 2 C═C double bonds), preferably linear, such as Z-11-hexadecenal, Z-9-tetradecenal, n-hexanal, 3-hexenal, octanal, or a mixture thereof.

The ester, preferably naturally emitted by plants, will preferably be an acetate, in particular an acetate having from 5 to 18 (e.g., 6 to 10 or 6 to 8) carbon atoms and comprising a saturated or unsaturated hydrocarbon chain (e.g., comprising one or more, in particular 1 or 2 C═C double bonds), preferably linear, may be 2-hexenyl acetate, octenyl acetate, hexadienyl acetate, or a mixture thereof.

The jasmonic derivative, preferably naturally emitted by plants, can be jasmone, methyl jasmonate, or a mixture thereof.

Advantageously, the core of the particles comprises, in particular consists of, based on the total weight of the core:
from 25% to 90%, particularly from 60% to 80%, by weight of oil,
from 8% to 50%, particularly from 8% to 35%, by weight of wax, and
from 0.1% to 25%, particularly from 0.5% to 20%, by weight of semiochemical compound.

The adjustment of the wax/oil/semiochemical ratios will, however, depend on the solubility of the semiochemical compound in the wax/oil mixture.

The particles of the present invention are in the form of more or less spherical structures. More particularly, the particles have an average size ranging from 0.2 μm to a few tens of micrometers, such as from 0.2 μm to 30 μm, for example from 0.5 μm to 20 μm, in particular from 1 μm to 10 μm. When the particles are spherical particles, the average particle size refers to the average particle diameter. When the particles are non-spherical, i.e., they have a longer dimension and a shorter dimension, the average particle size refers to the average of the longer dimension of the particles. The particle size can be measured by methods well known to the skilled person, such as laser particle sizing.

The aqueous phase of the composition according to the invention or of the second composition of the kit according to the invention comprises at least one ASE copolymer and a base selected from potassium hydroxide, sodium hydroxide, ammonium hydroxide and combinations thereof, so that the aqueous phase has a pH of between 7 and 9.5, in particular between 7 and 8.

Advantageously, the ASE copolymer is characterized in that it comprises, in particular consists of, based on the total weight of the copolymer, between 20% and 60% by weight of repeating units derived from metacrylic acid and between 40% and 80% by weight of repeating units derived from ethyl acrylate. The methods of producing such polymers are well known to those skilled in the art (see, for example, Alkali-Swellable and Alkali Soluble Thickener Technology A Review part Gregory D. Shay DOI: 10.1021/ba-1989-0223.ch025 Date of Publication: May 5, 1989 in Polymers in Aqueous Media Chapter 25, pages 457-494), and they can be found under the following trade names: Rheocoat™, Viscoatex™ from Coatex, Rheovis™ from BASF, Acrysol™ from DOW, Rheolate™ from Elementis. In particular, it may be Coatex's Rheocoat 35, BASF's Rheovis AS1130 or AS 1125, or Dow's Acrysol TT-615.

The base will be selected from ammonium hydroxide, sodium hydroxide, potassium hydroxide and combinations thereof; advantageously selected from ammonium hydroxide, sodium hydroxide and combinations thereof; and preferably will be ammonium hydroxide.

The base added to the aqueous phase in order to obtain a pH between 7 and 9.5 allows to neutralize the ASE copolymer. The carboxylic acid functions (COOH) present on the ASE copolymer are then in the form of carboxylates (COO—) whose counter-ion will depend on the nature of the added base and could therefore be Na⁺, K⁺ or NH₄⁺. This neutralization makes it possible to make the ASE copolymer film-forming.

The aqueous phase of the first composition of the kit according to the invention will advantageously have a pH of between 7 and 9.5, in particular between 7 and 8.

### Method for Preparing the Composition or Kit

The composition according to the invention can be prepared according to the following steps:
(i) preparing an aqueous suspension of the particles;
(ii) adding the at least one ASE copolymer; and
(iii) adding the base so as to obtain a pH between 7 and 9.5, preferably between 7 and 8.

As part of a kit according to the invention, the first composition can be prepared according to step (i) above, and the second composition can be prepared according to steps (ii) and (iii) above, step (ii) then being carried out on an aqueous phase devoid of particles according to the invention. The pH of the aqueous phases of the first and second compositions of the kit according to the invention will be adjusted, if necessary, at the end of the method, to the desired value, in particular as indicated above.

### Step (i):

The aqueous suspension of the particles is advantageously prepared according to the following steps:
(a) preparing a fatty phase comprising the wax, the oil and the semiochemical compound,
(b) heating the fatty phase at a temperature above the melting point of the wax,
(c) preparing an aqueous solution comprising the HASE copolymer, said aqueous solution having a pH between 8 and 10,
(d) heating the aqueous solution comprising the HASE copolymer at a temperature substantially identical to that of the fatty phase,
(e) adding the fatty phase to the aqueous solution comprising the HASE copolymer and stirring so as to form a dispersion of fatty phase droplets in the aqueous solution (which constitutes a continuous aqueous phase), and
(f) acidifying at a pH between 6 and 7.5, preferably between 6.5 and 7, to form the particles.

The fatty phase will be prepared in step (a) so as to obtain a mixture of wax, oil and a semiochemical compound having the core composition described above.

In a particular embodiment, the fatty phase is heated in step (b) at a temperature between 50° C. and 80° C., in particular between 60° C. and 80° C., this temperature having to be higher than the melting temperature of the wax.

The aqueous solution of step (c) can be prepared by basifying an aqueous solution comprising the HASE copolymer by adding a base, identical or different to the base used in step (iii), so as to obtain a pH of between 8 and 10. This base will advantageously be selected from sodium or potassium carbonate, ammonium hydroxide or ammonia in aqueous solution, sodium hydroxide, potassium hydroxide and combinations thereof.

In step (d), “substantially identical temperature” advantageously means a temperature that does not vary by more than 10° C., in particular by more than 5° C., with respect to the heating temperature of step (b). Preferably, the temperature in step (d) will be identical to that in step (b).

The fatty phase droplets formed in step (e) will form the core of the particles, once brought to room temperature.

The acidification in step (f) precipitates the HASE copolymer present in the aqueous solution onto the droplets, which then become particles comprising the core of wax, oil and semiochemical compound surrounded by the HASE copolymer-based solid envelope. These particles are dispersed in water and form an aqueous suspension of particles.

In a particular embodiment, the acidification in step (f) is carried out by adding an acid such as hydrochloric acid, phosphoric acid, sulfuric acid, an organic acid of the carboxylic acid type (particularly acetic acid or propionic acid) or a mixture thereof, particularly phosphoric acid, until reaching a pH between 6 and 7.5, preferably between 6.5 and 7. This acid is preferably added as an aqueous solution.

In another embodiment, step (f) and step (ii) are concomitant, with the ASE copolymer being used to acidify the aqueous solution.

The aqueous suspension can be prepared in particular as described in WO 2016/131883.

The temperature of the aqueous suspension of the particles obtained in step (f) is advantageously brought to a temperature below the melting point of the wax, in particular at a temperature of between 20° C. and 30° C., in particular before carrying out step (ii) (if this step is not concomitant with step (f)) and/or step (iii).

Steps (ii) and (iii):

The addition of the ASE copolymer and its neutralization by the addition of the base allows the aqueous suspension to become film-forming and to be used as a coating.

The base in step (iii) will advantageously be selected from ammonium hydroxide, sodium hydroxide, potassium hydroxide and combinations thereof.

Step (iii) will more particularly be carried out subsequently to or simultaneously with step (ii), preferably subsequently to step (ii).

Step (iii), and possibly step (ii), when not concomitant with step (f), is advantageously carried out at a temperature below the melting point of the wax, in particular at a temperature between 20° C. and 30° C.

### Method for Treating/Coating a Seed and Treated/Coated Seed

The present invention also relates to a method of treating a seed, which method comprises:
(a) the application of a composition according to the invention to a seed, more particularly coating a seed with a composition according to the invention, or
(b) the application to a seed of the second composition of the kit according to the invention, more particularly by coating; then the application, in one or more times, of the first composition of the kit according to the invention to the seed previously covered, more particularly coated, with the second composition of the kit according to the invention.

### Method (a):

The method of treating or coating the seed allows a solid film to be formed around the seed from a composition according to the invention.

This method advantageously comprises:
(1) contacting a composition according to the invention with the seed so as to form a film of composition around the seed, and
(2) drying the seed obtained in step (1).

Step (1) may be performed by placing the seed, and more particularly the seeds as several seeds are usually processed at the same time, in a rotating granular media mixer (e.g., concrete mixer type), and then adding the composition according to the invention so as to distribute it homogeneously on the seed/around the seeds.

Step (2) evaporates the water present in the composition according to the invention so as to form a solid layer around the seed, by a film forming phenomenon.

This method, in particular steps (1) and (2) above, may be repeated several times with the same composition according to the invention, with different compositions according to the invention (comprising in particular different semiochemical compounds) and/or with other compositions such as agrochemical coating compositions comprising other types of active agents or comprising no active agent. Thus, the seed may further be treated, in particular coated, with a composition other than a composition according to the invention.

It can indeed be considered:
to form a coating devoid of any active agent (so-called neutral coating) before forming the coating according to the invention, so as to further protect the seed from the phytotoxic effect of the semiochemical compound;
to form a coating devoid of any active agent after forming the coating according to the invention, so as to further protect the coating according to the invention from the external environment;
to form several coating layers according to the invention with the same semiochemical compound, so as to adapt the quantity of this compound deposited, and/or with different semiochemical compounds, so as to protect the seed against different pests;
to form one or more coatings with agrochemical coating compositions comprising other types of active agents (e.g., fungicide, growth promoter, fertilizer, etc.), so as to provide further benefits to the plant.

### Method (b):

The seed treatment or coating method allows a solid film to be formed around the seed from the second composition of the kit according to the invention, to which particles of semiochemical compound will adhere.

This method advantageously comprises:
(1′) contacting the second composition of the kit according to the invention with the seed so as to form a film of the second composition around the seed and obtain a film-coated seed,
(2′) contacting the film-coated seed obtained in step (1′) with the first composition of the kit according to the invention, so as to apply particles of semiochemical compound to the film-coated seed, and
(3′) drying the seed obtained in step (2′).

Step (1′) can be carried out by placing the seed, and more particularly the seeds as several seeds are generally treated at the same time, in a rotating granular media mixer (e.g., of the concrete mixer type), then adding the second composition of the kit according to the invention so as to distribute it evenly over the seed/around the seeds.

Step (2′) can be carried out by spraying the first composition onto the film-coated seeds obtained in step (1′) above. The first composition can be applied in the same rotating granular media mixer, so as to homogenize the distribution of the first composition on the coated seeds.

Step (3′) evaporates the water present in the first and second compositions of the kit according to the invention, so as to form a solid layer around the seed, by a film forming phenomenon.

This method, in particular steps (1′), (2′) and (3′) above, can be repeated several times with the same first and second compositions from the kit according to the invention, with different first and second compositions according to the invention (in particular comprising different semiochemical compounds) and/or with other compositions such as agrochemical coating compositions comprising other types of active agent or comprising no active agent. Thus, the seed can also be treated, in particular coated, with a composition other than a composition according to the invention or from a kit according to the invention.

It may in fact be possible to:
form a coating devoid of any active agent (so-called neutral coating) prior to the formation of the coating according to the invention, so as to further protect the seed from the phytotoxic effect of the semiochemical compound;
form a coating devoid of any active agent after formation of the coating according to the invention, so as to further protect the coating according to the invention from the external environment;
form several layers of coating according to the invention with the same semiochemical compound, so as to adapt the deposited quantity of this compound, and/or with different semiochemical compounds, so as to protect the seed against different pests;
form one or more coatings with agrochemical coating compositions comprising other types of active agents (e.g., fungicide, growth stimulator, fertilizer, etc.), so as to bring other benefits to the plant.

The present invention also relates to a seed treated, especially coated, with a composition according to the invention or using a kit according to the invention. As indicated above, it may also be treated several times with the same composition according to the invention/using the same kit according to the invention or with different compositions according to the invention/using different kits according to the invention.

The seed may furthermore be treated, in particular coated, with a composition other than that according to the present invention or using a kit according to the invention, in particular before and/or after treatment, in particular coating, with a composition according to the invention according to the invention or using a kit according to the invention. This makes it possible to form several layers around the seed, at least one of its layers having been obtained from a composition according to the invention or using a kit according to the invention. These layers may contain different active ingredients so as to confer different benefits to the plant, whether in terms of protection against harmful or undesirable organisms or in terms of stimulation of the plant growth.

More particularly, such a treated seed, in particular a coated seed, is likely to be obtained by the treatment method, in particular coating, detailed above. These seeds will be more resistant to pest attacks.

The seed can be more particularly selected among cereal seeds such as corn, wheat, barley, sorghum; seeds of protein-oleaginous plants such as colza, sunflower, soya; and seeds of vegetable plants such as carrots, radishes, turnips, salads, beans, melons, eggplants, squashes, zucchinis, garlics, onions, leeks.

Use of the Composition or Kit for the Protection of an Emerging Seed and/or Seedling

The present invention also relates to the use of a composition according to the invention or of a kit according to the invention to protect, more particularly in the soil, a seed, more particularly intended to be sown, and/or an emerging seedling against a pest.

The present invention also relates to a method of in-soil protection of an emerging seed and/or seedling against a pest, comprising the following steps:
applying to the seed an effective amount of a composition according to the invention or of the first and second compositions of the kit according to the invention, in particular by the method for treating a seed according to the invention, so as to obtain a treated seed, in particular a coated seed, and then
sowing the treated seed, in particular the coated seed, in the soil.

The composition or kit according to the invention allows indeed to confer a protection during the phase of germination of the seed and emergence of the plant, i.e., its emergence from the ground.

The emerging seed or seedling to be protected will be more particularly an emerging seed or seedling of a plant, advantageously selected from cereals such as corn, wheat, barley, sorghum; protein-oil plants such as rape, sunflower, soya; and vegetable plants such as carrots, radishes, turnips, salads, beans, melons, eggplants, squashes, zucchinis, garlic, onions, leeks.

The pest is a soil-borne pest, i.e., present in the growing environment of the seed. It will be more particularly the wireworm, beetle larvae, Otiorhynchus larvae, Tipula larvae, hepiale larvae, Ditylenchus dipsaci, nematodes vectors of virus such as Trichodorus or Longidoridae, nematodes generating cysts or galls on roots such as Meloidogynes or Globodera, or nematodes that dry out roots such as nematodes of the genus Pratylenchus. In particular Ditylenchus dipsaci are particularly harmful for carrots, onions, leeks, and turnips.

An advantage of the invention is the simplicity of preparation and use of the semichemical capsule suspensions, which facilitates industrial extrapolation both for the manufacture of the suspensions and for the manufacture of the coated seeds.

### EXAMPLES

### Example 1 (with a Composition According to the Invention)

### Raw Materials:

Table 1 below lists the raw materials used in the examples.

TABLE 1

| Raw materials | Supplier |
|---|---|
| Demineralized water | Ciron |
| 10% w/w soda solution in water | M2i |
| 16.6% w/w potash solution in water | M2i |
| 9.88 w/w ammonium hydroxide solution in water | M2i |
| Pharma 38 | Coatex |
| Sunflower oil | IES |
| Beeswax | Prayon |
| Thymol (CAS 89-83-8) | Aldrich |
| Rheocoat 35 | Coatex |
| Corn seeds | Ferrarix |

### Methods:

### Brookfield Viscosity Measurement

The viscosity measurements are performed on a Brookfield DV1 viscometer with the spindle SC04 25. The rotation speed of the spindle is indicated in revolutions per minute (RPM) for each measurement. Viscosities are measured at 25° C.

### Particle Size Measurement

Particle size measurements are performed with a Malvern Mastersizer MS3000 particle size analyzer. The sample to be analyzed is diluted in distilled water at the concentration of 0.5 g per 100 mL. The Mie scattering model is used to calculate the particle sizes with 1.5 as the value for the refractive index of the particles and 0.005 for their absorption coefficient. The values reported in the tables are the peak values.

Several tests are performed on the coated seeds to verify that the coating is satisfactory.

### Flow Test

The seed conveying is simulated in the tubes of a seed drill. The assembly consists of a funnel equipped with a pipe of 1 meter long and 2.7 cm of interior diameter. The test is successful if all the seeds loaded in the funnel flow without creating any obstruction.

### Sieving Test

One hundred seeds are sifted with a sieve that allows only individual seeds to pass. The test is successful if all the seeds pass through. The test fails if some seeds are agglomerated or sticky and do not pass through the sieve.

### Dissolution Test of the Coating Layer

A dissolution test is performed to ensure the permeability of the coating to water. Some seeds are put in a test tube filled with water for 16 hours. The seeds must come out completely washed from the coating.

### Germination Test

In order to verify if the coating has a possible phytotoxic effect on the seed, germination tests of coated seeds are performed since a phytotoxic effect would prevent this germination.

These tests can be conducted in two ways:
(1) or by sowing in planters containing a 50/50 mixture of topsoil and potting soil;
(2) or by artificial germination in a petri dish containing cotton that is moistened daily.

Method (1) has been used in the examples below.

The seed germination occurs after only a few days. If the seed does not germinate, it is concluded that the seed is dead.

### Crop Protection

Crop protection efficiency trials were conducted on corn in microplots, each modality being repeated 4 times. For each repetition, 4 rows of 12 m are sown. Observations were made on the 2 central rows and on 10 m (1 m of border was left at each end of the row). These trials were carried out in the region of Pau in France during the period from May to August 2021. It should be noted that these trials are multifactorial and cannot be interpreted without the laboratory tests previously described.

### Efficiency is Evaluated Via Several Ratings:

A) Percentage of emergence: determination of the percentage of plants that emerged, the plants that did not emerge being considered dead because they were attacked by wireworms;
B) Percentage of emerged plants attacked: determination of the percentage of plants showing characteristic symptoms of wireworm attack (e.g., yellowing of the foliage extremities with greater damage to the central leaf; reddening of the leaf blade; perforation above the tillering plate; perforation or laceration of the stem sheath; drying out of stunted plants . . . ) (this rating is made after the determination of the percentage of emergence);
C) Percentage of marketable ears: determination of the average size of an ear by taking into consideration all the modalities of the trial, then determination of the percentage of ears having a size higher than this one for each modality;
D) Production yield: yield measurement for each modality, plants that have been properly protected will have a better yield.

### 1. Preparation of Coating Compositions

### 1.1. Preparation of Coating Compositions According to the Invention (Compositions 1-4)

In a 250 ml glass flask, under magnetic stirring, the semiochemical compound, the oil and the wax are heated at T=76° C. until complete fusion to form an oil phase. In parallel, in a second 250 mL tricol flask, water and the HASE copolymer are heated at T=76° C. under mechanical stirring, then a basic solution (SB1) is added, and the medium is homogenized for 15 min in order to reach a pH>9 (pH1) and give an aqueous phase. The oil phase is then introduced on the aqueous phase under stirring (500-600 RPM) in 5-10 min. The medium is stirred for 1 h. The ASE copolymer is added to the mixture and the pH is adjusted, if necessary, to a pH of about 7 (the addition of the ASE copolymer and the adjustment of the pH by adding a basic solution (SB2) can be done successively or simultaneously, in one or more steps). The pH (pH2) is measured after 15 min of stirring.

The compositions 1-4 according to the invention were prepared from the raw materials according to Table 2.

TABLE 2

| | Comp. 1 | Comp. 2 | Comp. 3 | Comp. 4 |
|---|---|---|---|---|
| Raw materials | (weighed masses in g) | | | |
| Demineralized water | 41.41 | 64.19 | 59.19 | 54.21 |
| SB1/SB2: aqueous solution of B | 5.15 | 5.14 | 5.14 | 2.62 g |
| | (B = NaOH | (B = NaOH | (B = KOH | (B = NH₄OH |
| | 10% w/w) | 10% w/w) | 16.6% w/w | 9.88% w/w) |
| HASE copolymer: Pharma 38 | 4.01 | 4.02 | 4.00 | 3.99 |
| Sunflower oil | 25.16 | 3.22 | 3.22 | 3.22 |
| Beeswax | 8.29 | 3.21 | 3.22 | 3.22 |
| Semiochemical compound: Thymol | 10.00 | 15.01 | 15.01 | 14.99 |
| ASE copolymer: Rheocoat 35 | 4.99 | 5.00 | 5.00 | 5.00 |
| QSP of demineralized water | 0.78 | — | 5.01 | 12.74 |
| Recovered mass | 63.96 | 72.57 | 84.12 | 82.15 |

The results of the analyses performed for compositions 1˜4 according to the invention are shown in Table 3.

TABLE 3

| Analyses | Comp. 1 | Comp. 2 | Comp. 3 | Comp. 4 |
|---|---|---|---|---|
| pH1 | 9.80 | 9.80 | 10.51 | 9.12 |
| pH2 | 7.05 (63.5° C.) | 7.16 (66.1° C.) | 7.88 (73.6° C.) | 7.69 |
| Final pH | 7.13 (24.6° C.) | 7.38 (19.0° C.) | 7.23 (21.2° C.) | 7.69 (20.7° C.) |
| Viscosity | 2 100 000 | 763 200 | 704 000 | 1 082 000 |
| (in mPa)* | | | | |
| Particle | [2.5; 11.5] μm | [0.15; 10.0] μm | 1^{st} population: | 1^{st} population: |
| size | 1 peak at 3 μm | 1 peak at 0.5 μm | [0.15; 12] μm | [0.1; 1, 0] μm |
| | | 1 peak at 2 μm | 1 peak at 0.5 μm | 1 peak at 0.5 μm |
| | | | 1 peak at 3 μm | 2^{nd} population: |
| | | | 2^{nd} population: | [1, 0; 9, 0] μm |
| | | | [12; 300] μm | 1 peak at 3 μm |
| | | | 1 peak at 50 μm | |

*spindle speed: 0.3 RPM

1.2. Preparation of a Composition without Semiochemical Compound (Composition 5)

Water and ASE copolymer are stirred in a beaker. A basic solution (SB) is added in rapid dropwise fashion under vigorous mechanical stirring (600 RPM).

The final pH of composition 5 is 7.06 (20.4° C.). This formulation was prepared from the raw materials according to Table 4.

TABLE 4

| | Comp. 5 |
|---|---|
| Raw materials | (masses weighed in g) |
| Demineralized water | 93.10 |
| SB: aqueous solution of B | 4.06 |
| | (B = NaOH 10% w/w) |
| ASE copolymer: Rheocoat 35 | 6.43 |

### 2. Preparation of Coated Seeds

The seed coatings are made with a laboratory drum mixer with a volume of 1 L. The corn seeds are introduced into the device with the coating composition. The device is stirred at 50 rpm under air blowing inside the room to facilitate water evaporation for 1 hour.

When several coating layers are successively applied to the seeds, the above operation is repeated several times with different coating compositions.

The characteristics of the prepared seeds are described in Table 5 below.

TABLE 5

| Coating | | A | B | C | D | E |
|---|---|---|---|---|---|---|
| Corn seeds (g) | | 62.03 | 100.13 | 99.95 | 100.23 | 100.11 |
| Coa. 0 | Comp. No | — | 5 | 5 | 5 | 5 |
| | Quantity (g) | — | 2.61 | 2.60 | 2.57 | 2.66 |
| Coa. 1 | Comp. No | 2 | 2 | 3 | 4 | 2 |
| | Quantity (g) | 4.26 | 6.47 | 6.74 | 6.85 | 7.03 |
| Coa. 2 | Comp. No | — | — | — | — | 5 |
| | Quantity (g) | — | — | — | — | 2.65 |

### 3. Results Obtained

The application results obtained can be classified into three objectives: the quality of the coated seeds, the germination of the seed and the effect on the crop protection against pest attacks.

### 3.1. Quality of Coated Seeds

The results obtained with the different coatings A to E for the flow, sieving and dissolution tests of the coating layer are presented in Table 6 below.

TABLE 6

| Coating | A | B | C | D | E |
|---|---|---|---|---|---|
| Flow test | Successful | Successful | Failed | Successful | Successful |
| Sieving test | Successful | Successful | Failed | Successful | Successful |
| Dissolution | Successful | Successful | Successful | Successful | Successful |
| test | | | | | |

All these trials lead to seeds that can be sown because the seed coating remains sufficiently hydrophilic to allow the germination process. We note moreover that the choice of the nature of the base has an influence on the aspect of the coated seeds. The example C thus led to seeds less easily manipulated. This may be due to a higher water retention on the surface of the seeds. It is indeed known that potassium ions greatly favor water adsorption.

### 3.2. Results of the Germination Test

The results obtained with the different coatings A, B, D and E for the germination test are presented in Table 7 below.

TABLE 7

| Coating | A | B | D | E |
|---|---|---|---|---|
| Germination Test | Successful | Successful | Successful | Successful |

None of the coatings used alter the seed germination.

### 3.3. Crop Protection Results

The results obtained with the different coatings A, B, D and E on the crop protection against pest attacks (in particular the wireworm which is very present in the land selected for the trial) according to tests A) to D) are presented in Table 8 below, as well as the results obtained with the control T, i.e., uncoated seeds.

TABLE 8

| Coating | T | A | B | D | E |
|---|---|---|---|---|---|
| A) Percentage of emergence | 53% | 67% | 77% | 86% | 60% |
| B) Percentage of emerged | 69% | 65% | 55% | 38% | 66% |
| plants attacked | | | | | |
| C) Percentage of marketable | 58% | 67% | 81% | 80% | 61% |
| ears | | | | | |
| D) Production yield | 64% | 69% | 84% | 84% | 71% |

These trials confirm the trends observed in the laboratory tests. All seedlings according to the invention had better yields and fewer attacks than the untreated control.

### Example 2 (with a Kit According to the Invention)

The semiochemical compounds shown in Table 9 below were tested in formulations at 0.5% by weight of the weight of the first composition or at 5% by weight of the weight of the first composition.

TABLE 9

| Code | Compound |
|---|---|
| A | Z-11-hexadecenal |
| B | Z-9-tetradecenal |
| C | Methyl jasmonate |
| D | Jasmone |
| E | Terpene mixture |
| | (5% α-pinene, 5% β-pinene, 13% β-cayrophyllene, |
| | 13% limonene, 15% camphor, 12% camphene, 16% |
| | geraniol, 16% citronellol, 5% de sabinene) |
| F | n-Hexanal |
| G | 2-Hexenyl acetate |
| H | Octanal/Octenyl acetate |
| 1 | 3-hexenal/hexdienyl acetate |

### Preparation of the First Composition of the Kit

Formulations with 0.5% Semiochemical Compound:

5 g of semiochemical compound, 350 g of sunflower oil and 150 g of cosmetic-grade beeswax are introduced into a first stirred reactor maintained at 80° C.

450 ml of water, heated to 80° C. and kept stirring, is introduced into a second reactor. Then 30 g of HASE copolymer (Pharma 38) are added. The pH of the solution is then adjusted from 3 to 8.5 by gently adding a 5% sodium hydroxide solution. The solution thickens, and the contents of the first reactor are added dropwise with stirring. At the end of the addition, the mixture is left to homogenize for one hour, then the pH is adjusted to 7.7 using a 1% phosphoric acid solution. The formulations referenced COAT05A-1 are obtained, depending on the nature of the semiochemical compound.

Formulations with 5% Semiochemical Compound:

50 g semiochemical compound, 325 g sunflower oil and 125 g cosmetic-grade beeswax are introduced into a first stirred reactor, maintained at 80° C. 450 ml of water, heated to 80° C. and kept stirring, is introduced into a second reactor. Then 40 g of HASE copolymer (Pharma 38) are added. The pH of the solution is then adjusted from 3 to 8.5 by gently adding a 5% sodium hydroxide solution. The solution thickens, and the contents of the first reactor are added dropwise with stirring. At the end of the addition, the mixture is left to homogenize for one hour, then the pH is adjusted to 7.7 using a 1% phosphoric acid solution. The formulations referenced COATSA-I are obtained, depending on the nature of the semiochemical compound.

### Corn Seed Coating

Formulations COAT05A-1 and COATSA-I are used in the coating method described below. 100 g of corn seeds are introduced into a 1 L rotary agitator. The agitator is maintained at a surface temperature of 40° C. by means of a heated oil bath.

14 g of a 7% aqueous solution of ASE copolymer (Rheocoat 35), neutralized to pH 8 by a 1 M potash solution, are added to the stirrer.

5 ml spray bottles are then prepared to contain 4 g of the previously prepared COAT05A-1 and COAT5A-I formulations. The shaker is then sprayed with 4 g of the chosen formulation, spreading the spray over 10 min to allow each spray to dry thoroughly. The shaker is left to run for 15 min after the addition is complete, then the seeds are removed from the shaker and placed in an airtight aluminum bag. The result is coated corn seeds referenced MCOAT05A-1 and MCOATSA-I, depending on the nature of the formulation sprayed.

### Germination and Repulsion Trials

### Germination Trials

20 corn seeds coated with each treatment are placed in pots of potting soil. These pots are watered and maintained at 25° C. in ambient light. A control trial is run in parallel under the same conditions with untreated seeds (TNT), and another control trial is run with seeds treated with 0.1% of the pure terpene mixture (TT). The number of ungerminated seeds is then counted after 10 days.

### Repulsion Trials

To test the repellent effect of the seeds, the same trial is carried out for each sample of treated seeds.

In a square pot of compressed cellulose, 8 cm square and 10 cm high, filled with potting soil, we place a treated seed of corn and three wireworm larvae freshly collected and stored in moist potting soil at 8° C. The larvae can emerge by eating the pot envelope. The pots are watered regularly and kept at 25° C. under natural light. After 20 days, we count the number of beetles that have escaped from the pots, and by emptying the pots, we count the larvae that are still alive. For each type of coating, the experiment is carried out on 10 pots to obtain a statistical analysis of the effect of the coating.

### Results

The results are reported in Table 10 below.

TABLE 10

| | Number of | Germi- | | | |
|---|---|---|---|---|---|
| | germinated | nation | Number of | | Larval |
| Reference | seeds at | rate at | escaped | Repulsion | mortality |
| Trial | 10 days | 10 days | larvae | rate (%) | rate (%) |
| TNT | 20 | 100 | NA | NA | NA |
| TT | 2 | 10 | NA | NA | NA |
| MCOAT05A | 17 | 85 | 5 | 17 | 13 |
| MCOAT05B | 18 | 90 | 8 | 27 | 10 |
| MCOAT05C | 20 | 100 | 3 | 10 | 0 |
| MCOAT05D | 20 | 100 | 5 | 17 | 0 |
| MCOAT05E | 15 | 75 | 10 | 33 | 4 |
| MCOAT05F | 13 | 65 | 4 | 13 | 33 |
| MCOAT05G | 17 | 85 | 12 | 40 | 13 |
| MCOAT05H | 14 | 70 | 4 | 13 | 30 |
| MCOAT05I | 14 | 70 | 4 | 13 | 27 |
| MCOAT5A | 13 | 65 | 3 | 10 | 27 |
| MCOAT5B | 15 | 75 | 3 | 10 | 33 |
| MCOAT5C | 20 | 100 | 10 | 33 | 0 |
| MCOAT5D | 19 | 95 | 10 | 33 | 0 |
| MCOAT5E | 12 | 60 | 3 | 10 | 83 |
| MCOAT5F | 15 | 75 | 0 | 0 | 87 |
| MCOAT5G | 13 | 65 | 4 | 13 | 80 |
| MCOAT5H | 10 | 50 | 0 | 0 | 77 |
| MCOAT5I | 11 | 55 | 0 | 0 | 73 |

NA: not applicable

The TT, MCOAT05E and MCOAT5E trials show that the coating according to the invention limits the phytotoxic effect of the terpene mixture on the seed. Generally speaking, the coating according to the invention limits the phytotoxic effect of the semiochemical compound on the seed, since at least half the seeds germinate even at high semiochemical compound levels.

The protection of seeds by the coating has also been demonstrated by the repulsion and larval mortality induced by this coating, as certain semiochemical compounds may only have a repulsive effect, with no lethal effect.

1. A composition comprising particles suspended in an aqueous phase, wherein:
the particles comprise a solid envelope surrounding a core, wherein:
the solid envelope comprises at least one HASE copolymer, and
the core represents at least 90% by weight of the total weight of the particles and comprises a mixture of wax, oil and a semiochemical compound,
wherein the aqueous phase comprises at least one ASE copolymer and a base selected from ammonium hydroxide, sodium hydroxide, potassium hydroxide and combinations thereof, so that the aqueous phase has a pH of from 7 to 9.5.

2. A kit comprising:
a first composition comprising particles suspended in a first aqueous phase, wherein:
the particles comprise a solid envelope surrounding a core, wherein:
the solid envelope comprises at least one HASE copolymer, and
the core represents at least 90% by weight of the total weight of the particles and comprises a mixture of wax, oil and a semiochemical compound, and
a second composition comprising, in a second aqueous phase, at least one ASE copolymer and a base selected from ammonium hydroxide, sodium hydroxide, potassium hydroxide and combinations thereof, so that the second_aqueous phase has a pH of from 7 to 9.5.

3. The composition according to claim 1, wherein the HASE copolymer contains, based on the total weight of the copolymer:
from 30% to 40% by weight of repeating units derived from methacrylic acid,
from 45% to 60% by weight of repeating units derived from ethyl acrylate, and
from 5% to 20% by weight of repeating units derived from a macromonomer of the formula Chem. I: 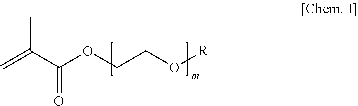
where
m is an integer from 1 to 40, and
R is a hydrocarbon group of formula CₙH₂ₙ₊₁ in which n is an integer from 9 to 25.

4. The composition according to claim 1, wherein the ASE copolymer contains, based on the total weight of the copolymer:
from 20% to 60% by weight of repeating units derived from metacrylic acid, and
from 40% to 80% by weight of repeating units derived from ethyl acrylate.

5. The composition according to claim 1, wherein the core of the particles contains, based on the total weight of the core:
from 25% to 90% by weight of oil,
from 8% to 50% by weight of wax, and
from 0.1% to 25% by weight of semiochemical compound.

6. The composition according to claim 1, wherein:
the wax is selected from the group consisting of beeswax, lanolin wax, Chinese insect wax, rice wax, carnauba wax, candelilla wax, jojoba wax, ouricurry wax, esparto wax, cork fiber wax, sugar cane wax, Japan wax, sumac wax, montan wax, microcrystalline waxes, and mixtures thereof; and/or
the oil is selected from the group consisting of sunflower oil, peanut oil, soybean oil, rapeseed oil, corn oil, olive oil, grape oil, walnut oil, linseed oil, palm oil, coconut oil, argan oil, avocado oil, almond oil, hazelnut oil, pistachio oil, rice oil, cottonseed oil, wheat germ oil, sesame oil, and mixtures thereof.

7. (canceled)

8. The composition according to claim 1, wherein the semiochemical compound is selected from thymol, geraniol, alpha-pinene, beta-pinene, limonene, camphor, camphene, sabinene, menthol, eucalyptol, β-caryophyllene, β-ocimenes, citronellol, linalool and its acetate, lavandulyl acetate, terpineols, terpinenes, Z-11-hexadecenal, Z-9-tetradecenal, n-hexanal, 3-hexenal, octanal, 2-hexenyl acetate, octenyl acetate, hexadienyl acetate, jasmone, methyl jasmonate, er and a mixture thereof.

9. A method of preparing a composition according to claim 1, comprising the following steps:
(i) preparing an aqueous suspension of the particles;
(ii) adding the at least one ASE copolymer; and
(iii) adding the base so as to obtain a pH from 7 and to 9.5.

10. The method according to claim 9, wherein the base of step (iii) is selected from ammonium hydroxide, sodium hydroxide, potassium hydroxide and combinations thereof.

11. The method according to claim 9, wherein step (i) comprises the following steps:
(a) preparing a fatty phase comprising the wax, the oil and the semiochemical compound,
(b) heating the fatty phase at a temperature above the melting point of the wax to obtain a heated fatty phase,
(c) preparing an aqueous solution comprising the HASE copolymer, the aqueous solution comprising the HASE copolymer having a pH from 8 to 10,
(d) heating the aqueous solution comprising the HASE copolymer at a temperature substantially identical to that of the fatty phase to obtain a heated aqueous solution comprising the HASE copolymer,
(e) adding the heated fatty phase to the heated aqueous solution comprising the HASE copolymer and stirring so as to form a dispersion of fatty phase droplets in the aqueous solution, and
(f) acidifying at a pH from 6 to 7.5, to form the particles,
wherein step (f) can be concomitant with step (ii).

12. A method of treating a seed comprising:
the application of a composition comprising particles suspended in an aqueous phase to a seed, wherein
the particles comprise a solid envelope surrounding a core, wherein:
the solid envelope comprises at least one HASE copolymer, and
the core represents at least 90% by weight of the total weight of the particles and comprises a mixture of wax, oil and a semiochemical compound,
wherein the aqueous phase comprises at least one ASE copolymer and a base selected from ammonium hydroxide, sodium hydroxide, potassium hydroxide and combinations thereof, so that the aqueous phase has a pH of from 7 to 9.5,
or
the application of a first composition to a seed; then the application, in one or more times, of a second composition to the seed previously covered with the first composition of the kit, wherein:
the first composition comprises, in a first aqueous phase, at least one ASE copolymer and a base selected from ammonium hydroxide, sodium hydroxide, potassium hydroxide and combinations thereof, so that the first aqueous phase has a pH of from 7 to 9.5, and
the second composition comprises particles suspended in a second aqueous phase, the particles comprise a solid envelope surrounding a core, wherein:
the solid envelope comprises at least one HASE copolymer, and
the core represents at least 90% by weight of the total weight of the particles and comprises a mixture of wax, oil and a semiochemical compound.

13. The method according to claim 12, wherein the seed is further treated with a composition other than the compositions of claim 12.

14. A seed coated with the composition of claim 1.

15. The seed coated according to claim 14, wherein the seed is selected among cereal seeds, seeds of protein-oleaginous plants.

16.-18. (canceled)

19. The kit according to claim 2, wherein the HASE copolymer contains, based on the total weight of the copolymer:
from 30% to 40% by weight of repeating units derived from methacrylic acid,
from 45% to 60% by weight of repeating units derived from ethyl acrylate, and
from 5% to 20% by weight of repeating units derived from a macromonomer of the formula Chem. I: 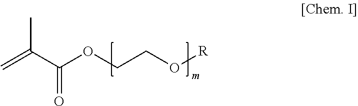
where
m is an integer from 1 to 40, and
R is a hydrocarbon group of formula CₙH₂ₙ₊₁ in which n is an integer from 9 to 25.

20. The kit according to claim 2, wherein the ASE copolymer contains, based on the total weight of the copolymer:
from 20% to 60% by weight of repeating units derived from metacrylic acid, and
from 40% to 80% by weight of repeating units derived from ethyl acrylate.

21. The kit according to claim 2, wherein the core of the particles contains, based on the total weight of the core:
from 25% to 90% by weight of oil,
from 8% to 50% by weight of wax, and
from 0.1% to 25% by weight of semiochemical compound.

22. The kit according to claim 2, wherein:
the wax is selected from the group consisting of beeswax, lanolin wax, Chinese insect wax, rice wax, carnauba wax, candelilla wax, jojoba wax, ouricurry wax, esparto wax, cork fiber wax, sugar cane wax, Japan wax, sumac wax, montan wax, microcrystalline waxes, and mixtures thereof; and/or
the oil is selected from the group consisting of sunflower oil, peanut oil, soybean oil, rapeseed oil, corn oil, olive oil, grape oil, walnut oil, linseed oil, palm oil, coconut oil, argan oil, avocado oil, almond oil, hazelnut oil, pistachio oil, rice oil, cottonseed oil, wheat germ oil, sesame oil, and mixtures thereof.

23. The kit according to claim 2, wherein the semiochemical compound is selected from thymol, geraniol, alpha-pinene, beta-pinene, limonene, camphor, camphene, sabinene, menthol, eucalyptol, β-caryophyllene, β-ocimenes, citronellol, linalool and its acetate, lavandulyl acetate, terpineols, terpinenes, Z-11-hexadecenal, Z-9-tetradecenal, n-hexanal, 3-hexenal, octanal, 2-hexenyl acetate, octenyl acetate, hexadienyl acetate, jasmone, methyl jasmonate, and a mixture thereof.

24. A method for protecting in soil a seed and/or an emerging seedling obtained from the seed against a pest insect or nematode comprising a step of sowing the seed which has been first treated in order to form a coated seed according to claim 14.

25. The method according to claim 19, wherein:
the seed and/or emerging seedling is a seed and/or emerging seedling of a plant selected from cereals, protein-oil plants, and vegetable plants, and/or
the pest insect or nematode is the wireworm, beetle larvae, Otiorhynchus larvae, Tipula larvae, hepiale larvae, Ditylenchus dipsaci, nematodes vectors of virus, nematodes generating cysts or galls on roots, or nematodes that dry out roots.
